(19) United States
(12) Patent Application Publication
(10) Pub. No.: US 2014/0347031 A1
(43) Pub. Date: Nov. 27, 2014

(54) CONTROL DEVICE FOR A DC-DC CONVERTER

(71) Applicant: Hella KGaA Hueck & Co., Lippstadt (DE)

(72) Inventor: Thomas Schmitz, Lippstadt (DE)

(21) Appl. No.: 14/285,353

(22) Filed: May 22, 2014

(30) Foreign Application Priority Data
May 23, 2013 (DE) 102013105264.9

(51) Int. Cl. G05F 3/08

(52) U.S. Cl. CPC G05F 3/08
USPC 323/304

(57) ABSTRACT

A control device for a dc-dc converter. The control device is designed for an increase and a decrease in the output power of the dc-dc converter, and the increase in the output power occurs at a different speed than the decrease.

### CROSS REFERENCE

This application claims priority to German Patent Application No. 10 2013 105264.9, filed May 23, 2013, which is hereby incorporated by reference.

### FIELD OF THE INVENTION

The invention relates to a control device for a direct current to direct current [dc-dc] converter, and a system comprising such a control device and a dc-dc converter and a method for controlling a dc-dc converter.

### BACKGROUND

Direct current to direct current [dc-dc] converters are used, among other things, for the purpose of converting an input voltage on an input side into an output voltage on an output side. In so doing, electric energy is transmitted from the input side to the output side. An output power, which is the product of the output voltage and the output current, is outputted on the output side. The output voltage is usually determined by electric devices, such as, for example, electric consumers, that are connected to the dc-dc converter. The output power can be regulated by closed loop control of the output current.

Like all electric devices, the temperature of a dc-dc converter increases during normal operations due to a dissipation of the electric power that is converted into heat. In this case the higher the output power, the faster the temperature rises and the higher the temperature becomes. Other parameters also influence the temperature of the dc-dc converter, such as, for example, the outside temperature of the dc-dc converter and the heat dissipation of the dc-dc converter. In order to prevent the dc-dc converter from overheating, a so-called derating is provided. This means that the output power of the dc-dc converter is reduced, when the temperature of the dc-dc converter exceeds a specified temperature threshold. When the temperature drops below this temperature threshold, the output power is increased again.

In this case the temperature threshold has to be below a critical temperature, at which it is necessary to be concerned about the dc-dc converter being damaged or destroyed, in order to avoid precisely such problems. However, at the same time the temperature threshold should also be as high as possible, in order to be able to achieve as high an output power as possible for the maximum possible length of time, so that the dc-dc converter can be operated during normal operations under rated conditions. Therefore, on overshooting or undershooting the temperature threshold the output power is adapted relatively fast. However, the output power cannot be controlled at an arbitrary speed. The dead times and tolerances of the dc-dc converter and the control device limit this speed. Therefore, the temperature threshold, at which the output power is supposed to be decreased, has to be lower than the critical temperature by a tolerance value that takes this into consideration.

The relatively fast control of the output power can result in electrical fluctuations in the current circuit that is connected to the dc-dc converter. This is also caused by dead times and tolerances of the control device, the dc-dc converter and the electric devices that are attached.

In addition, the temperature of the dc-dc converter tracks an increase or decrease in the output power with a time delay due to the thermal inertia of said dc-dc converter. If, therefore, the output power is reduced because the temperature threshold was exceeded, then it takes a certain amount of time until the temperature also begins to drop. The same applies to the increase in the output power and the increase in the temperature. As a result, even the temperature always fluctuates in a relatively large range about the temperature threshold; and the output power is frequently increased and decreased.

### SUMMARY OF THE INVENTION

In contrast to the aforesaid, the object of the present invention is to provide a control device of the type described in the introductory part of the specification in such a way that the electrical fluctuations are at least minimized.

This engineering object is achieved by means of a control device conforming to its genre and exhibiting the characterizing features disclosed in patent claim 1. Embodiments of the invention are disclosed in the dependent claims.

Since the increase in the output power is carried out at a different speed than the decrease, fluctuations are suppressed. If, for example, after a relatively fast decease in the output power, the temperature drops below the temperature threshold, then the output power is increased again only relatively slowly. In this way electrical fluctuations are minimized by increasing and decreasing the output power in rapid succession. The same also applies if the increase in the output power takes place faster than the decrease.

The term output power is understood here to mean, in particular, the power that is outputted by the current circuit that is connected to the output side of the dc-dc converter. In this case the dc-dc converter transmits an energy from the input side to the output side. Hence, the output side of the dc-dc converter is the side, to which energy is transmitted from the input side.

The concept increase in the output power is understood here to mean, in particular, that the output power is increased from an actual value to a setpoint value. The change occurs during a time interval. The term speed is understood here to mean, in particular, the difference between the setpoint value and the actual value in relation to the time interval. It is possible that the change takes place continuously or in several discrete steps. During the time interval the control device can output control signals that control the output power of the dc-dc converter.

The concept decrease in the output power is understood here to mean, in particular, that the output power is reduced from an actual value to a setpoint value. The change occurs during a time interval. The term speed is understood here to mean, in particular, the difference between the actual value and the setpoint value in relation to the time interval. It is possible that the change takes place continuously or in several discrete steps. During the time interval the control device can output control signals that control the output power of the dc-dc converter.

For example, the setpoint value of the control device may differ from the setpoint value of the dc-dc converter. The concept setpoint value of the control device is understood here to mean, in particular, the value for the output power that the dc-dc converter is supposed to output after the increase or decrease of the output power. This setpoint value may also be called the target value. The concept setpoint value of the dc-dc converter is understood to mean the value for the output power that was transmitted to the dc-dc converter by means of the control signals of the control device. The increase or decrease in the output power is carried out by an approximation of the setpoint value of the dc-dc converter to the setpoint value of the control device.

Then a speed is referred to as lower or less than another speed, if its amount is lower than the amount of the other speed.

According to one embodiment of the invention, the increase in the output power can be carried out more slowly than the decrease in the output power. The concept a slower increase is understood here to mean, in particular, that the speed of the increase is lower than the speed of the decrease.

This feature has, in particular, the advantage that the output power can be reduced relatively late, in order to avoid damage to the dc-dc converter. Owing to the relatively fast decrease, the dc-dc converter can be operated at a high output power for a relatively long time during normal operations under rated conditions. Nevertheless, fluctuations in the current circuit that is attached are reduced, because the increase in the output power takes place relatively slowly. Owing to the relatively slow increase in the output power, the temperature increase occurs with a relatively small time delay, so that the fluctuation of the temperature about the temperature threshold is minimized. The temperature of the dc-dc converter sets itself to a range slightly above and below the temperature threshold.

According to one embodiment of the invention, the increase in the output power can be triggered by an undershooting of a temperature threshold. In order to determine the temperature, the control device can receive, for example, temperature signals of a temperature sensor. In this case said temperature signals include a reference to the temperature of the dc-dc converter. It is also possible that the control device receives a signal from a temperature sensor that includes a reference to the undershooting of the temperature threshold. If the temperature falls below the temperature threshold due to the lower output power, then the output power is increased comparatively slowly, so that the temperature also increases relatively slowly. In the event that there is a change in the output power, the temperature of the dc-dc converter changes with a time delay because of its thermal inertia. The relatively slow increase in the output power makes it possible to decrease this time delay, so that the temperature variations are reduced.

It is possible for there to be a plurality of temperature thresholds. Thus, for example, a relatively low first target value for the output power can be determined for overshooting a first relatively high temperature threshold, whereas for overshooting a second relatively low temperature threshold a second target value that is higher than the first target value is determined. It is also possible to establish a temperature range, to which a target value range is assigned. In this temperature range it is possible to establish, for example, a linear correlation between the temperature of the dc-dc converter and the target value.

According to one embodiment of the invention, the decrease in the output power can be triggered by an overshooting of the temperature threshold. In combination with the relatively fast decrease in the output power the temperature threshold can be put relatively close to the critical temperature of the dc-dc converter, so that the dc-dc converter can also be operated with a relatively high output power at relatively high temperatures. Consequently in combination with a relatively slow increase in the output power on undershooting the temperature threshold electrical fluctuations are avoided, while a relatively high output power can be outputted at a relatively high temperature of the dc-dc converter.

According to one embodiment of the invention, the control device can be designed to fulfill the objective of increasing the output power by an increase in the output current. In this way the output voltage can be kept constant.

According to one embodiment of the invention, the control device can be designed to fulfill the objective of reducing the output power by a decrease in the output current. In this way the output voltage can be kept constant.

According to one embodiment of the invention, the control device can be designed for an exponential increase and for an exponential decrease of the output power. Such an exponential increase or decrease respectively can be achieved, for example, by means of a PT1 element. For example, the control device can calculate initially a setpoint value of the control device for the output power, where this setpoint value depends on the temperature of the dc-dc converter. Then a first signal, for example a ramp from the actual value to the setpoint value of the control device, can be used as the input signal for the PT1 element. Then the output signal of the PT1 element can be used as a control signal for the dc-dc converter. In the case of a linear input signal the output signal of the PT1 element exhibits an exponential shape. In this way an exponential decrease and/or an exponential increase in the output power can be achieved without a lot of computational complexity.

How fast the output signal of the PT1 element changes depends more or less on two factors, i.e. the input signal and the time constants of the PT1 element. Different speeds in the course of increasing and decreasing the output power can be achieved by means of different time constants for the increase and the decrease. For example, the time constant for the increase of the output power can be greater than the time constant for the decrease of the output power. In this way it is possible to meet the objective that the exponential increase of the output power is slower than the exponential decrease.

The time constant for the decrease of the output power can be, for example, in an order of magnitude of the dead time of the dc-dc converter, including the tolerances. The time constant for the increase of the output power can be, for example, greater by 2 to 5, preferably 3 to 4, orders of magnitude.

In this case the PT1 element can be an integral part of the control device. However, it is also possible that the PT1 element is connected between the control device and the dc-dc converter.

According to one embodiment of the invention, the control device can be designed to fulfill the objective of carrying out continuously the increase and/or decrease of the output power.

The control device and the PT1 element can be designed as electronic circuits. The control device and/or the PT1 element can be designed, for example, as an integrated circuit.

In an additional aspect the invention relates to a system comprising a control device in accordance with one embodiment of the invention and a dc-dc converter.

In yet another aspect the invention relates to a method for controlling a dc-dc converter, so that with this method the increase in the output power takes place at a different speed than the decrease in the output power.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a flow diagram of the steps running in a control device for a dc-dc converter according to one embodiment of the invention; and

FIG. 2 is a graphical representation of the different time constants for the increase and the decrease of the output power of the dc-dc converter.

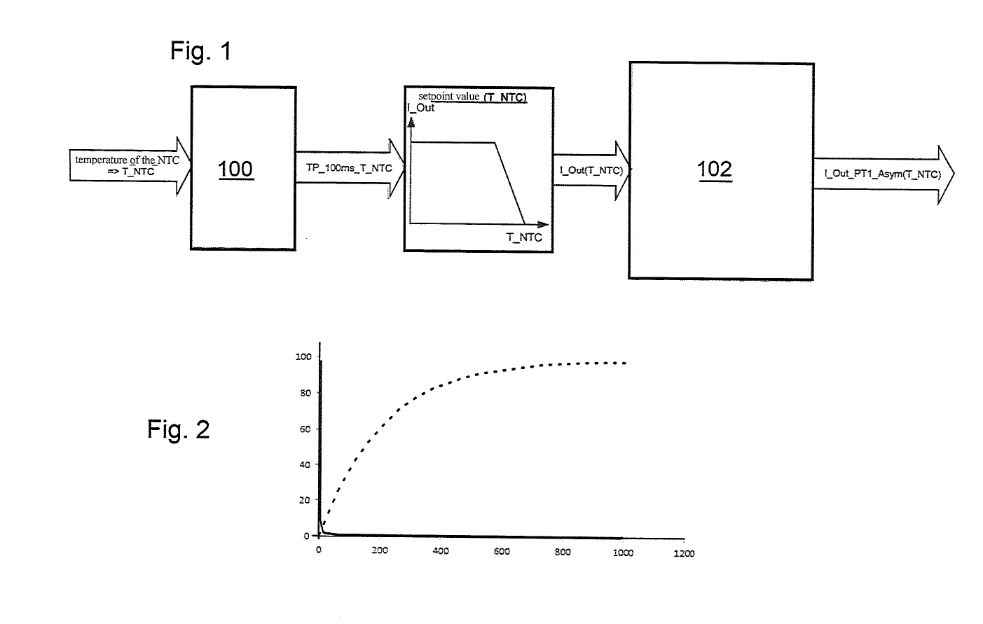

In FIG. 1 a signal T_NTC of a temperature sensor is used initially as the input variable. The temperature sensor can be, for example, an NTC resistor. The signal T_NTC relates to at least the actual temperature of the dc-dc converter. Ideally the signal T_NTC includes the temperature of the dc-dc converter. The temperature sensor can be arranged, for example, inside the dc-dc converter.

The signal T_NTC is filtered by means of a low pass filter 100, in order to filter out the measurement errors and undesired signal peaks. Jumps in the signal T_NTC can be easily considered to be measurement errors, because it cannot be expected that the temperature of the dc-dc converter will change suddenly. The time constant of the low pass filter can amount to, for example, 100 ms.

The output signal of the low pass filter T_100 ms_T_NTC is further processed in the control device. Each temperature value T_NTC is assigned a setpoint value of the output power. The output power can be realized, for example, by matching the maximum permissible output current. As a result, the setpoint value for the output current I_Out(T_NTC) depends on the temperature of the dc-dc converter. This setpoint value can also be referred to as the setpoint value of the control device or the target value. The target value I_Out(T_NTC) is used as the input signal for the PT1 element 102.

The PT1 element 102 has varying time constants. If the target value is greater than the actual value of the output power, then the time constant of the PT1 element 102 is relatively large. If the target value is less than the actual value of the output power, then the time constant of the PT1 element 102 is relatively small. Hence, the time constant is greater for an increase of the output power than for a decrease. The time constant for the decrease in the output power can be, for example, in an order of magnitude of the dead time of the dc-dc converter and any tolerances. Therefore, the PT1 element can also be referred to as the PT1 element with asymmetrical time constants.

The output signal I_Out_PT1_Asym(T_NTC) of the PT1 element 102 is used as the control signal for the dc-dc converter. This output signal can also be called the setpoint value of the dc-dc converter. This setpoint value may differ from the target value. When the output power is increased or decreased, the setpoint value is approximated to the target value. When the setpoint value has reached the target value, the increase or decrease is terminated.

The profile of the setpoint value of the dc-dc converter, i.e. the output signal of the PT1 element 102, is shown graphically by way of example in FIG. 2. In this case the time, for example in seconds, is plotted in the X direction; and the output current, for example, in percent, is plotted in the Y direction. The curve that is shown as a dashed line corresponds to the profile of the output signal of the PT1 element 102 when the output power of the dc-dc converter is increased, while the curve that is shown as a solid line corresponds to the profile of the output signal of the PT1 element 102 when the output power of the dc-dc converter is reduced. It is clearly evident that the decrease in the output power occurs considerably faster than the increase in the output power.

In this way it is possible to adjust a temperature threshold that lies relatively close to the critical temperature of the dc-dc converter that gives cause to be concerned about damage to the dc-dc converter. At the same time electrical fluctuations and fluctuations in the temperature about this temperature threshold are minimized by the relatively slow increase in the output power. The temperature of the dc-dc converter continues to fluctuate only in a very narrow range below and slightly above the temperature threshold.

### LIST OF REFERENCE NUMERALS

100 low pass filter
102 PT1 element

1. A control device for a dc-dc converter, wherein the control device is designed for an increase and a decrease in the output power of the dc-dc converter, and wherein the increase in the output power occurs at a different speed than the decrease.

2. The control device, as claimed in claim 1, wherein the increase in the output power is carried out more slowly than the decrease in the output power.

3. The control device, as claimed in claim 1, wherein the increase in the output power is triggered by an undershooting of a temperature threshold.

4. The control device, as claimed in claim 1, wherein the decrease in the output power is triggered by an overshooting of the temperature threshold.

5. The control device, as claimed in claim 1, wherein the control device is designed to increase the output power by an increase in the output current.

6. The control device, as claimed in claim 1, wherein the control device is designed to reduce the output power by a decrease in the output current.

7. The control device, as claimed in claim 1, wherein the control device is designed for an exponential increase and for an exponential decrease in the output power.

8. The control device, as claimed in claim 7, wherein a time constant of the exponential increase is smaller than a time constant of the exponential decrease of the output power.

9. The control device, as claimed in claim 1, wherein the control device is designed to carry out continuously the increase and/or the decrease in the output power.

10. A system comprising a control device, as claimed in claim 1, and a dc-dc converter.

11. A method for controlling a dc-dc converter, said method comprising the following step:
increasing and decreasing the output power of the dc-dc converter, wherein the increase occurs at a different speed than the decrease.
